(19) United States
(12) Patent Application Publication
(10) Pub. No.: US 2007/0050235 A1
(43) Pub. Date: Mar. 1, 2007

(54) System and Method of Modeling and Optimizing Product Parameters from Hierarchical Structure

(75) Inventor: Kenneth J. Ouimet, Scottsdale, AZ (US)

Correspondence Address: QUARLES & BRADY, LLP, ONE RENALSSANCE SQUARE, TWO NORTH CENTRAL AVENUE, PHOENIX, AZ, 85004, US

(73) Assignee: SAP AG, Waldorff (DE)

(21) Appl. No.: 11/468,266

(22) Filed: Aug. 29, 2006

Related U.S. Application Data
(63) Continuation-in-part of application No. 11/495,086, filed on Jul. 28, 2006.
(60) Provisional application No. 60/712,630, filed on Aug. 29, 2005.

(51) Int. Cl. G06F 17/30

(52) U.S. Cl. 705/10

(57) ABSTRACT

A computer-implemented method involves modeling of product decisions in a retail store. The product decision variables are profit, assortment, placement, promotion, and inventory. Various rules and constraints such as facing elasticity, shelf replenishment costs, shelf space, carrying costs, facing capacity, slotting fees, and cannibalization are defined for multiple product decision variables. An objective function utilizes the rules and constraints for the multiple product decision variables. Other product parameters are organized into a hierarchal structure. A function is defined for each product parameter and a control variable is selected to control each product parameter function. The hierarchical structure can use brand hierarchy, enterprise hierarchy, or customer buying decisions. The objective function simultaneously models each of the multiple product decision variables by iteratively resolving the objective function into values which optimize sales, revenue, and profit for the retail store. The model is output in graphic format.

### CLAIM TO DOMESTIC PRIORITY

The present non-provisional patent application is a continuation-in-part of and claims priority to U.S. patent application Ser. No. 11/495,086, filed Jul. 28, 2006, entitled “System and Method of Assortment, Space, and Price Optimization in Retail Store,” which is incorporated herein in its entirety. The present non-provisional patent application further claims priority to provisional application Ser. No. 60/712,630, entitled “Retail Resource Management,” filed Aug. 29, 2005.

### FIELD OF THE INVENTION

The present invention relates in general to statistical modeling for retail stores and, more particularly, to a system and method for hierarchically modeling and optimizing product parameters taken from a hierarchical structure.

### BACKGROUND OF THE INVENTION

Retail stores are in business to sell merchandise and make a profit. Store managers are most concerned with product-related marketing and decisions such as product placement, assortment, space, price, promotion, and inventory. If the products are non-optimized in terms of these product decisions, then sales can be lost and profit will be less than what would otherwise be possible in an optimal system. For example, if the product assortment, space, or inventory is not properly selected or maintained, then the consumer is less likely to buy these products. If price is too high or too low, then profit can be lost. If promotions are not properly targeted, then marketing efforts will be wasted. If the product placement is poorly laid-out, then the store loses sales.

In order to maximize the outcome of product related decisions, retail store management has used statistical modeling and strategic planning to optimize the decision making process for each of the product decisions. Economic modeling and planning is commonly used to estimate or predict the performance and outcome of real systems, given specific sets of input data of interest. A model is a mathematical expression or representation which predicts the outcome or behavior of the system under a variety of conditions. An economic-based system will have many variables and influences which determine its behavior. In one sense, it is relatively easy to review historical data, understand its past performance, and state with relative certainty that the system's past behavior was indeed driven by the historical data. A much more difficult task, but one that is extremely important and valuable, is to generate a mathematical model of the system which predicts how the system will behave, or would have behaved, with different sets of data and assumptions. The field of probability and statistics has provided many tools which allow predictions to be made with reasonable certainty and acceptable levels of confidence.

In its basic form, the economic model can be viewed as a predicted or anticipated outcome of a mathematical expression, as driven by a given set of input data and assumptions. The input data is processed through the mathematical expression representing either the expected or current behavior of the real system. The mathematical expression is formulated or derived from principles of probability and statistics, often by analyzing historical data and corresponding known outcomes, to achieve an accurate correlation of the expected behavior of the system to other sets of data. In other words, the model should be able to predict the outcome or response of the system to a specific set of data being considered or proposed, within a level of confidence, or an acceptable level of uncertainty. As a simple test of the quality of the model, if historical data is processed through the model and the outcome of the model using that historical data is closely aligned with the known historical outcome, then the model is considered to have a high confidence level over the interval. The model should then do a good job of predicting outcomes of the system to different sets of input data.

Economic modeling has many uses and applications. One emerging area in which modeling has exceptional promise is in the retail sales environment. Grocery stores, general merchandise stores, specialty shops, and other retail outlets face stiff competition for limited customers and business. Most, if not all, retail stores make every effort to maximize sales, volume, revenue, and profit. Economic modeling can be a very effective tool in helping store owners and managers achieve these goals.

Retail stores engage in many different strategies to increase sales volume, revenue, and profit. Retailers must take into account many different considerations in optimizing overall sales volume, revenue, and profit. Product assortment, space, and inventory must be considered. Product price is also important. Product placement in terms of aisle, shelf height, page, and adjacencies must be taken into account. Product promotion is an important factor.

Retailers have used a variety of modeling tools to represent and optimize one or more of the product decisions described above, i.e., product placement, assortment, space, price, promotion, and inventory. One modeling tool may optimize for placement. Another modeling tool will optimize for product assortment, space, and inventory. Yet another modeling tool may optimize for price. Still another modeling tool will predict the optimal promotions. Each modeling tool may yield good results for the specific criteria being considered. However, historical modeling tools generally optimize for only one product decision. The process of optimizing one product decision may not necessarily optimize another product decision. Indeed, optimizing one product decision may be counter-productive to the best solution for another product decision. For example, optimizing product placement, e.g., giving a product a low visibility location, may be counter to optimizing product promotion in that customers may have difficulty finding the advertised product.

By optimizing for only one product decision, or individually for multiple product decisions, then the overall product sales and profit will be sub-optimal. With the present modeling tools, it is difficult, if not impossible, to optimize for all product decisions at once. Either certain product decisions are not considered, or the process of optimizing certain product decisions will detract from other product decisions. In any case, the overall product sales and profit, taking into account all product decisions, is not optimized with present modeling tools.

### SUMMARY OF THE INVENTION

In one embodiment, the present invention is a computer-implemented method of modeling product parameters in a retail store comprising the steps of organizing product parameters into a hierarchal structure, defining a function for each product parameter, selecting a control variable to control each product parameter function, providing an objective function that utilizes the control variables and product parameter functions, and modeling each of the product parameters by iteratively resolving the objective function into values which optimize sales, revenue, and profit for the retail store.

In another embodiment, the present invention is a computer program product usable with a programmable computer processor having a computer readable program code embodied therein comprising computer readable program code which organizes product parameters into a hierarchal structure, defines a function for each product parameter, selects a control variable for each product parameter function, provides an objective function that utilizes the control variables and product parameter functions, and models each of the product parameters by iteratively resolving the objective function into values which optimize sales, revenue, and profit for the retail store.

In another embodiment, the present invention is a computer system for modeling product parameters in a retail environment comprising means for organizing product parameters into a hierarchal structure, means for defining a function for each product parameter, means for selecting a control variable to control each product parameter function, means for providing an objective function that utilizes the control variables and product parameter functions, and means for modeling each of the product parameters by iteratively resolving the objective function into values which optimize sales, revenue, and profit for the retail store.

### BRIEF DESCRIPTION OF THE DRAWINGS

FIG. 1 is a block diagram of retail business process using a modeling tool to simultaneously resolve multiple product decisions;

FIG. 2 is a retail store shelf with product assortment and spacing;

FIG. 3 is a plot of sales response versus product facings;

FIG. 4 is a hierarchical structure of enterprise levels;

FIG. 5 is a plot of shelf space versus price image;

FIG. 6 is a hierarchical structure of branded products;

FIG. 7 is a hierarchical structure of customer buying decisions;

FIG. 8 is a hierarchical structure of assortment and pricing zones;

FIG. 9 is a computer system for executing the modeling tool; and

FIG. 10 illustrates the steps of modeling multiple product parameter functions each with a control variable taken from a hierarchical structure of product parameters.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

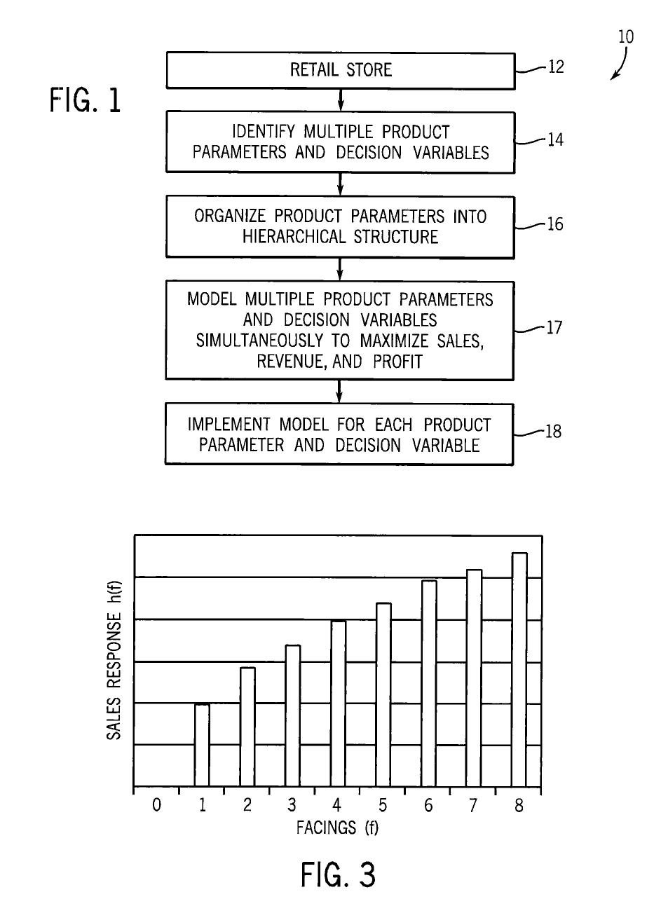

Referring to FIG. 1, in retail process 10, retail store (retailer) 12 has certain product lines or services available for sale to customers as part of its business plan. The terms products and services are used interchangeably in the present discussion. Retailer 12 may be a food store chain, general products retailer, drug store, clothing store, discount warehouse, department store, specialty store, etc. A store may be a single location, or a chain or logical group of stores.

Retailer 12 desires to optimize multiple product decisions in order to maximize sales, revenue, and profitability. Retailer 12 has the ability to set pricing, order inventory, run promotions, arrange its product displays, collect and maintain historical sales data, and adjust its strategic business plan. The management team of retailer 12 is held accountable for market share, profits, and overall success and growth of the business. While the present discussion will center on retailer 12, it is understood that the economic modeling tools and data processing system described herein are applicable to other enterprises and businesses having similar goals, constraints, and needs.

Retailer 12 has a business or operational plan. The business plan includes many planning, analyzing, and decision-making steps and operations. The business plan gives retailer 12 the ability to evaluate performance and trends, make strategic decisions, set pricing, order inventory, formulate and run promotions, hire employees, expand stores, add and remove product lines, organize product shelving and displays, select signage, and the like. The business plan allows retailer 12 to analyze data, evaluate alternatives, run forecasts, and make operational decisions. Retailer 12 can change the business plan as needed. As one important tool to allow retailer 12 to successfully execute on its business plan, the management team needs accurate economic models.

Economic and financial modeling has many uses and applications; it is an important business tool which allows companies to conduct business planning, forecast demand, manage supply chains, control inventory, manage manufacturing, predict revenue, and optimize price and profit. One emerging area in which modeling has exceptional promise is in the retail sales environment. Grocery stores, general merchandise stores, specialty shops, and other retail outlets face stiff competition for limited customers and business. Most if not all retail stores make every effort to maximize sales, volume, revenue, and profit. Economic modeling can be a very effective tool in helping store owners and managers achieve these goals.

From its business plan, retailer 12 provides certain observable data and assumptions to an enterprise model. The enterprise model includes the concept of economic models as well as process, placement, assortment, pricing, scheduling, inventory, optimization, supply, demand, and other decision-based modeling. The enterprise model performs a series of complex calculations and mathematical operations to predict and forecast the business functions in which retailer 12 is most interested. Retailer 12 receives back specific forecasts and predictions, usually in graphic form to aid in understanding the retail system. The output of the model is a report, graph, chart, table, or other analysis, which represents the model's forecasts and predictions based on the model parameters and the given set of data and assumptions. The report allows retailer 12 to make operational decisions.

Retail stores 12 are interested in optimizing product sales, revenue, and profit while taking into account multiple product parameters and decisions. Retailer 12 must decide what products to display, how much space to give each product, where to place the products, and what price to charge (number of facings), all within the constraints of limited shelf space and the need to control price image. One product decision is assortment, space, and inventory. Assortment refers to which products will be placed on the retail shelves. Space refers to how much area will be allocated to each product. Inventory refers to how much product will be maintained by retailer 12, whether on the shelf, in the stockroom, or in other warehousing facilities. Another product decision is product placement which includes selection of aisle, front of store, end-aisle, shelf height, page, and adjacencies. Another product decision is pricing, which spans the entire product life cycle from introduction through termination of the product line. Another product decision is promotion, which includes special offers, media exposure, and timing.

Each of the product parameters and decisions, including placement, assortment, space, price, promotion, and inventory, is important in optimizing product sales, revenue, and profit. If the customer cannot find a product, or a product does not catch his or her eye, or if there is insufficient stock on the shelf to meet demand, then sales may be lost. If the price is too high or too low, then profit is lost. If the product is not properly promoted, then marketing efforts are wasted. If the product inventory is too high or too low, then again potential sales are lost or overhead costs are too high. Retailers must make products available, appealing, and priced-right to maximize sales and profit.

In block 14 of retail process 10, retailer 12 determines or identifies which of many possible product parameters and decisions are important to model and optimize, e.g. product assortment, space, inventory, placement, price, and promotion. In block 16, product parameters are organized into a hierarchical structure. The product parameters are taken from the hierarchical structure for selectively insertion into the model. The hierarchal structure provides expanded visibility into the factors influencing the product decisions. In block 17, the retail process models the identified multiple product parameters and decisions simultaneously to maximize sales, revenue, and profits. In block 18, retailer 12 implements the model for each product parameter and decision, i.e. stocks its shelves and sets pricing according to the model's output. Since the model operates on multiple product parameters and decisions simultaneously, it can find the optimal combination that achieves the best overall business plan for retailer 12.

The simultaneous modeling approach has distinct advantages over the independent modeling as found in the prior art. While one individual model may determine that a particular product is not profitable and therefore not deserving of shelf space, the pricing component of the multiple decision model may ascertain that by raising the price, the product can be made profitable again.

The model allows retailer 12 to define rules and constraints that will control the modeling process. The rules and constraints take into account certain physical, economic, and business realities that retailer 12 must manage. The following discussion considers many of the possible rules and constraints that can be placed into the product decision model. Once the rules and constraints are understood, the present statistical model for simultaneously modeling multiple product parameter and decision variables will be discussed in detail.

When considering buying decisions, customers often consider pricing, assortment (variety of products on the shelf), quality, convenience, and brand. Therefore, retailer 12 must give special attention to what products to offer, how much space to allocate (number of facings) to each product, and how much inventory to maintain on hand for immediate purchase. Product assortment is a powerful non-price competitive lever.

Retailer 12 must also consider a variety of costs, incentives, and constraints. For example, slotting fees are available as revenue to retailer 12. Slotting fees allow vendors to effectively buy shelf space. The vendor pays fees to retailer 12 for the opportunity to utilize a certain number of facings. Retailer 12 must contend with shelf replenishment cost, i.e., the cost for a worker to put more products on the shelf and the cost of running out of stock and losing sales. There are also inventory carrying costs, which is the cost of capital dedicated to maintaining inventory.

Retailer 12 can increase sales and profit by optimizing assortment and space. Retailer 12 may decide to offer “n” different brands of products in a particular category, e.g., laundry detergent, and then decide to give each brand fᵢ number of facings. The products have a per unit volume, so the facings consume shelf space horizontally and vertically. Brand X may have two horizontal facings and brand Y may have two horizontal by three vertical facings (six facings total). However, there is limited shelf space. Too few facings can lead to higher shelf replenishment costs or stock-outs. Too many facings waste valuable shelf space, which adds costs in inventory and cannibalizes other products. Cannibalization refers to the situation where increasing sales of one product may decrease sales of another product. Cannibalization is important in determining where sales migrate when a product is removed. Too few products lead to lost sales when customers cannot find the desired product. Too many products leads to confusion in the purchasing decision and lost sales if the consumer gives up without selecting a product. Retailer 12 must take into account that different products have different sizes, margins, and velocities.

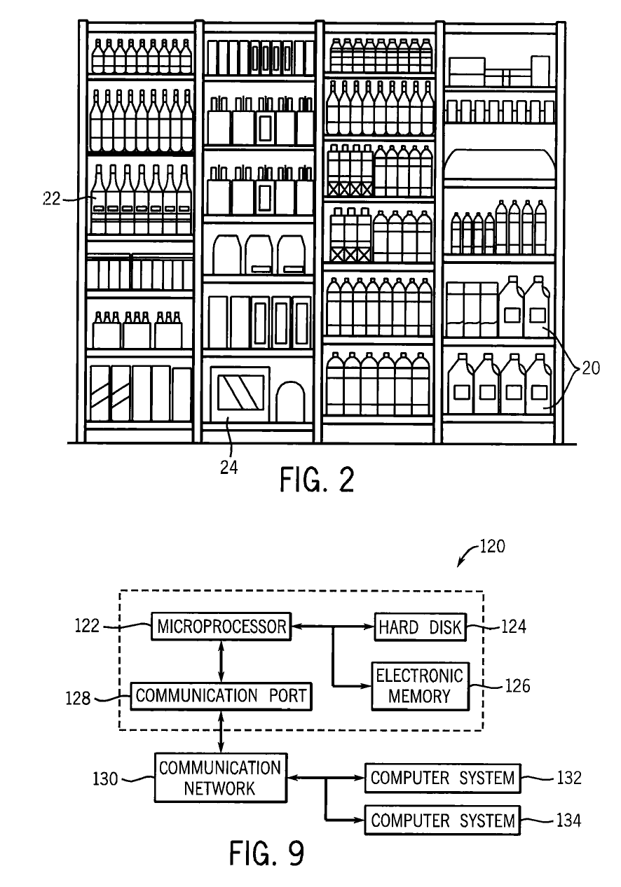

In developing the rules and constraints for the product decision model, retailer 12 must first consider product attributes. Product attributes includes current facings, facing area, facing capacity, slotting fee, shrinkage, and cost of capital in inventory. There are carrying costs for store delivery frequency, pack size, and minimum pack order. There are also shelf replenishment costs for fixed shelf costs, day replenishment costs, and night replenishment costs. A shelf has length, height, and depth as shown in FIG. 2. Shelf space constraints must take into account the size of each product in terms of its own length, width, height, number of facings, total shelf area, and variance between stores in total shelf area. In FIG. 2, product 20 is shown with six facings; product 22 has seven facings; and product 24 has one facing. The shelf space constraint allows retailer 12 to customize shelf layout on a per store basis as well as take into account demographics of the store location. The shelf space constraint can be given in equation (1) as:
Σᵢƒᵢ*Aᵢ≦SA (1)
where: fᵢ is facings for item i Aᵢ is facing area for item i SA is available shelf area

Another factor in optimizing assortment and spacing is facing elasticity. Facing elasticity considers how sales change with variation in space. The greater the number of facings, the greater the probability that the customer will see the product and make a purchase decision. Facing elasticity can be measured directly from historical change in planograms (product-oriented layouts of store shelves), or measured indirectly by comparing stores with different planograms. Facing elasticity can also be inferred from similar products or stores, or from expert intuition. Facing elasticity is given in equation (2) as:

$${ɛ}_{f} = \frac{\% Δ us}{\% Δ f} \qquad ( 2 )$$

where: numerator is percent change in unit sales denominator is percent change in facings

The facing elasticity model represents sales response h(f) versus number of facings (f) as shown in FIG. 3. Notice that more facings increases sales response h(f), but the increasing number of facings have diminishing returns with facing elasticity <1. The sales response is given in equation (3) as:
h(ƒ)=ƒ^{ε}^{_{ƒ}} (3)

In most cases, increasing the facings of product A will cannibalize or decrease the sales of product B. A cannibalization model is given in equation (4) as:
g(p)=>g(p)h(ƒ) (4)

The shelf replenishment costs are given in equations (5) and (6). Shelf capacity (SC) is the maximum units stored on a shelf. In equation (5), shelf capacity is a function of facings and facing capacity (FC). In equation (6), shelf replenishment frequency is a function of unit sales and shelf capacity.

$$\begin{matrix}{SC}_{i} = {f}_{i} * {FC}_{i} & ( 5 ) \\ {v}_{i}^{shelf} = \frac{{US}_{i}}{{SC}_{i}} & ( 6 )\end{matrix}$$

Shelf replenishment costs are generally linear with shelf replenishment frequency, although the slope of the function differs between night and day. Day costs are generally higher and will cause a greater slope for shelf replenishment costs.

Carrying costs take into account cost of capital, shrinkage, cost of product, and store inventory. Carrying costs are explained in equations (7) and (8) as follows:

$$\begin{matrix}{I}_{i}^{max} = \frac{{US}_{i}}{{DF}_{i}} & ( 7 ) \\ {CC}_{i} = {r}_{i}^{*} {c}_{i}^{*} {I}_{i}^{max} & ( 8 )\end{matrix}$$

where: CCᵢ is store delivery frequency DFᵢ is store delivery frequency rᵢ is cost of capital cᵢ is cost of product

With a number of rules and constraints understood, the discussion turns to the product decision model. An important feature of the model is its ability to simultaneously resolve multiple product decisions, e.g. assortment, space, inventory, placement, price, and promotion. The model includes a general objective function that is further defined in terms of individual relationships. The objective function is resolved iteratively by starting with an initial value and then using each iteration of the model to provide values for the next iteration. Once the objective function is maximized, the product decisions that went into the model are considered optimized. The output of the model is a report that retailer 12 can use to implement the results of the modeling exercise. The report can be graphical in format and give optimized price, facings, assortment, and placement. The report can further provide tabular data on projected unit sales, gross profit, contribution profit, slotting fees, shelf replenishment costs, and carrying costs.

The product decision model uses an objective function to resolve the various rules and constraints that will maximize sales, revenue, and profit. The general format of the objective function is given in equations (9)-(11). Notice that the objective function takes into consideration various decision variables, such as account profit, sales, price image, and shelf area. The Lagrange multiplier X provides a control mechanism to set different strategies and control individual decision variables. Equations (10) and (11) break down the general equation (9) into item components.

$$\begin{matrix}max θ [ \{ x \} ] = π [ \{ x \} , \{ us \} ] + {λ}^{ds} DS [ \{ us \} ] + {λ}^{im} PI [ \{ x \} ] + {λ}^{sa} SA [ \{ x \} ] & ( 9 ) \\ = {\sum }_{i} {θ}_{i} [ {x}_{i} , {us}_{i} ] & ( 10 ) \\ {θ}_{i} [ {x}_{i} , {us}_{i} ] = {π}_{i} [ \{ {x}_{i} \} , \{ {us}_{i} \} ] + {λ}^{ds} {DS}_{i} [ \{ {us}_{i} \} ] + {λ}^{im} {PI}_{i} [ \{ {x}_{i} \} ] + {λ}^{sa} {SA}_{i} [ \{ {x}_{i} \} ] & ( 11 )\end{matrix}$$

where:
SAᵢ|xᵢ|=xᵢAᵢ
PIᵢ[xᵢ]=rᵢ(gᵢ(pᵢ)hᵢ(xᵢ)|pᵢ, xᵢ┘−gᵢ(pᵢ)hᵢ(xᵢ)[xᵢ, rᵢ )
DSᵢ[usᵢ]=usᵢpᵢ
πᵢ[usᵢ, xᵢ]=usᵢ(pᵢ−cᵢ)+SFᵢ[xᵢ]−SRCᵢ[usᵢ,xᵢ]−CCᵢ[usᵢ]
π is profit
xᵢ is a decision variable (e.g. facings) for each item i
Aᵢ is area per facing
usᵢ is units sales
λ^{ds} is Lagrange multiplier for dollar sales
DSᵢ is dollar sales
λ^{im} is Lagrange multiplier for price image
PIᵢ is price image
λ^{sa} is Lagrange multiplier for shelf area
SAᵢ is shelf area
cᵢ is cost
pᵢ is price
rᵢ is reference price

Various costs and constraints are defined in the following equations.

$$\begin{matrix}{us}_{i} [ \{ {x}_{i} \} ] = D ( t ) \frac{{g}_{i} ( {p}_{i} ) {h}_{i} ( {x}_{i} )}{y [ \{ x \} ]} & ( 12 ) \\ y [ \{ x \} ] = \frac{ψ {\sum }_{k} {r}_{k} {g}_{k} [ {x}_{k} ]}{\overline{Z}} + ( 1 - ψ ) & ( 13 ) \\ {RC}_{i} [ \{ {x}_{i} , {us}_{i} \} ] = \{ \begin{matrix}{c}_{i}^{r , fix} + {c}_{i}^{r , night} {w}_{i} , w \leq 1 \\ {c}_{i}^{r , fix} + {c}_{i}^{r , night} + {c}_{i}^{r , day} ( {w}_{i} - 1 ) , w > 1\end{matrix} & ( 14 ) \\ {w}_{i} [ {x}_{i} , {us}_{i} ] = \frac{{us}_{i}}{{x}_{i} {FC}_{i}} & ( 15 ) \\ {CC}_{i} [ \{ {us}_{i} \} ] = {r}^{c} {c}_{i} \frac{{us}_{i}}{{DF}_{i}} & ( 16 ) \\ {SF}_{i} [ {x}_{i} ] = {x}_{i} {SF}_{i}^{pf} & ( 17 )\end{matrix}$$

where: RCᵢ is shelf replenishment cost model wᵢ is shelf replenishment frequency FC is facing capacity (units per facing) Cᵢ^{r,fix} is fixed replenishment cost Cᵢ^{r,night} is night replenishment cost Cᵢ^{r,day} is day replenishment cost CCᵢ is carrying cost model f^{c} is cost of capital cᵢ is product cost DFᵢ is delivery frequency SFᵢ is slotting fee per facing

The initialization of the objective function requires estimates for y and γ, see equations (18) and (19). The current store values, e.g. current number of facings, are used for estimate x=x^{c}.

$$\begin{matrix}{y}^{0} = y [ \{ {x}^{c} \} ] & ( 18 ) \\ {γ}^{0} = \frac{θ ⌊ \{ {x}^{c} \} ⌋ - {λ}^{sa} SA ⌊ \{ {x}^{c} \} ⌋}{{y}^{0}} & ( 19 )\end{matrix}$$

where: y⁰ is initial value of y γ⁰ is initial value of γ

With the initial value y⁰ and γ⁰, the process of maximizing the objective function of equation (9) begins with the nested algorithm as given in equations (20)-(24).

$$\begin{matrix}{γ}^{*} = max θ [ \{ f ( γ ) \} ] & ( 20 ) \\ y [ {x}^{*} \text{\vert} {y}^{*} , γ ] = \frac{ψ {\sum }_{k} {r}_{k} {g}_{k} [ {x}^{*} [ {y}^{*} γ , ] ]}{\overline{Z}} + ( 1 - ψ ) & ( 21 ) \\ \to {y}^{*} ( γ ) \text{:} max Ω [ y \text{\vert} γ ] & ( 22 ) \\ \to {x}^{*} [ y , γ ] \text{:} max {Ω}_{i} [ {x}_{i} \text{\vert} y , γ ] & ( 23 ) \\ {Ω}_{i} [ {x}_{i} \text{\vert} y , γ ] = {π}_{i} [ {us}_{i} , {x}_{i} ] + {λ}^{ds} {us}_{i} {p}_{i} + {λ}^{im} {us}_{i} {r}_{i} + {λ}^{sa} {x}_{i} {A}_{i} - \frac{γ ψ {r}_{i} {g}_{i} ( {p}_{i} ) {h}_{i} ( {x}_{i} )}{\overline{Z}} & ( 24 )\end{matrix}$$

Equations (20)-(24) represent a nested loop which is iteratively solved to maximize θ from equation (9). In the highest loop, the goal is to find γ=γ* that maximizes θ. In the lowest loop defined by equations (22) and (23), the goal is to find the values of x* and y* to maximize Ω in terms of y and γ. The solution starts with initial values of y⁰ and γ⁰ as given by equations (18) and (19). In maximizing Ω in equations (23) and (24), the function may be calculated in discrete steps, checking all values of x and y, or the function may be calculated in a continuous fashion, e.g. by gradient search. Within the lowest loop, once a set of values for x* and y* are determined using iterative values of y and γ, then these values for x and y* are inserted into equation (21) to determine a value for the function of y as given. This value for y is inserted into equations (12) and (13) to determine unit sales. The value for unit sales is inserted into equations (10) and (11) to determine θ.

The process repeats with each new calculation of values. That is, each time new values for y and γ are found, the loop returns to equations (23) and (24) to determine new values for x and y*. Each time new values for x and y are calculated, the loop returns to equation (21) to re-calculate the function of y. The function of y is again feed into equations (12) and (13) for an updated unit sales, which in turn gives a new value for θ. The loop repeats until the objective function θ is maximized to provide optimal values for the product decision variables being considered. One or more of the product decision variables including assortment, space, inventory, placement, price, and promotion can be readily integrated into equations (20)-(24) to simultaneously resolve the multiple model parameters. Thus, the product decision modeling tool simultaneously optimizes each of the multiple product decision variables by iteratively resolving the objective function from equations (9)-(11) into values which optimize sales, revenue, and profit for retailer 12. Maximizing the objective function θ as described above will optimize these parameters for the retail store.

In one embodiment, the product decision model is configured to model all product decision variables simultaneously. Alternatively, the model can be configured to model individual product decision variables, or specific combinations of the product decision variables.

The aforedescribed optimization has maximized product decisions, e.g. in terms of net profit, by taking into account various revenue and expenses, such as gross profit, slotting fees, shelf replenishment costs, carrying costs, and shrinkage, all within the strategic objectives of shelf space, facings, price image, category and brand sales, and product assortment, and tactical rules of pricing assortment, and space. The outcome provides optimized decisions as to assortment, space, and price. The optimization determines the best prices with brand selection and facings that lead to the maximum profit.

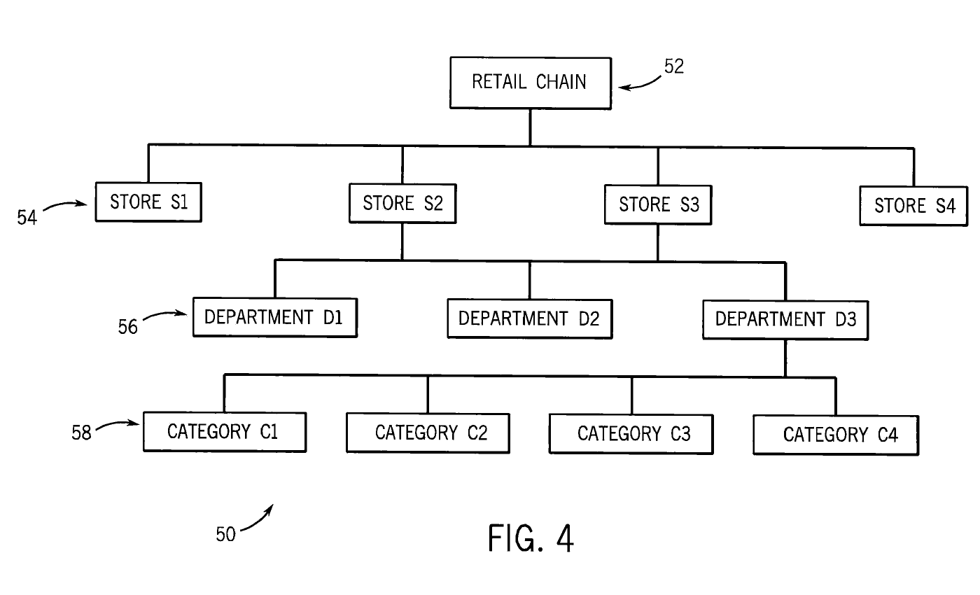

One way to consider the optimization of product decisions is through a hierarchical structure. The hierarchical optimization splits the problem into different layers and allows formulation of strategies at different points in the hierarchical structure. Retailer 12 can thus interact with the product decisions at different levels of hierarchy and evaluate the optimization derived from such an approach. FIG. 4 illustrates one such hierarchical structure 50 as different levels within a chain of retain stores. Level 52 represents the enterprise level of the chain of retail stores. Level 54 shows individual stores S1, S2, S3, and S4, all within the retail chain. Level 56 represents departments D1, D2, and D3 within a particular store, in this case store S2. Stores S1 and S3 will have similar departments within their respective grouping. Level 58 represents categories of products C1, C2, C3, and C4 within each department, in this case department D3. Departments D1 and D2 will have similar categories of products.

The hierarchical structure 50 of FIG. 4 allows retailer 12 to consider various groupings of its products and associated product parameters organized in the hierarchy as shown. In FIG. 4, product parameters can be the nodes within hierarchical structure 50 or elements such as store, department, and category. Through the hierarchical structure 50, retailer 12 can focus on a particular category of products within a particular department of a particular store. Alternatively, retailer 12 can focus on all categories of products within a particular department of a particular store; retailer 12 can focus on all categories of products in all departments of a particular store; or retailer 12 can focus on all categories of products in all departments in all stores of the retail chain. In any case, the hierarchal structure 50 shown in FIG. 4 gives retailer 12 many different options in organizing the products to be optimized. The optimization can be performed at any node or group of nodes according to the hierarchical structure.

To accomplish this feature, each node of hierarchal structure 50, e.g. category C1 of department D3 of store S2, can be represented as product function with a Lagrange multiplier similar to the functions shown in equation (9) of the simultaneous optimization process described above. The product function is based on the criteria that the product parameter represents. Each category of product for each department of each store has a unique set of historical data. For example, category C1 of department D3 of store S2 represents one or more product(s) with historical data for sales, assortment, space, placement, promotion, inventory, price, etc. Other categories in hierarchical structure 50 will have different sets of historical data. The product function describes the behavior of the product category. The Lagrange multiplier is a scalar multiplier uniquely selected and assigned for each node of hierarchical structure 50 to control the effect of the product function on maximizing the objective function θ. That is, each Lagrange multiplier is a weighting factor with a numeric value used to control the effect of the product category node(s) of FIG. 4 on the objective function θ. The Lagrange multiplier can be selected by retailer 12, e.g. as a normalized value between 0.0 to 1.0, to control the effect of the product function on the objective function. Thus, by viewing the structure 50 hierarchically, the category nodes(s) can be grouped and described as product functions with selectable and controllable scalar multipliers. The optimization for the objective function θ is then solved as described above for equations (9)-(24) to maximize its effect for the product decisions.

The product parameter functions and Lagrange multiplier(s) for the product category nodes of FIG. 4 can be used in addition to product decision functions and control multipliers λ^{ds}, λ^{im}, and λ^{sa} of equation (9), or in lieu of one or more of these standard product decision control factors. The Lagrange multiplier(s) for the product category nodes gives retailer 12 another means of controlling product decisions, e.g. for merchandising and assortment planning.

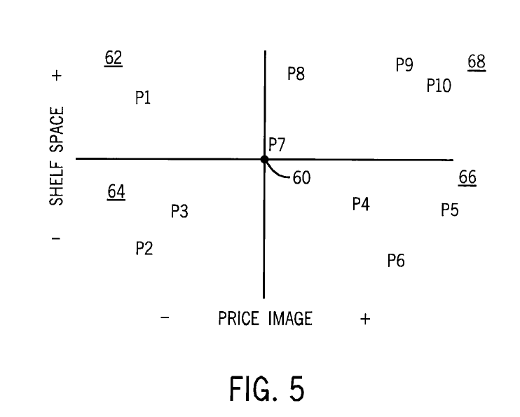

FIG. 5 illustrates an output of the optimization process for a number of products P1-P10. In FIG. 5, shelf space is plotted against price image to visualize how these parameters interact so that retailer 12 can formulate brand strategies. Center 60 denotes that the optimization has provided little or no change in shelf space or price image from prior arrangements and settings. Product P7 falls in the no-change area. Quadrant 62 generally shows that shelf space should increase and price image should decrease as a result of the solution of the objective function θ. Product P1 is located in quadrant 62 as exemplarily of this optimization. The solution to the objective function has placed products P2 and P3 in quadrant 64 to recommend that these products each receive a decrease in both shelf space and price image. Products P4, P5, and P6 are placed in quadrant 66 to receive less shelf space but a higher price image. Products P4-P6 are examples of brand sensitivity in that some products can get by with less shelf space and still command a higher price while maximizing profit. The objective function has shown that loyal customers will find products P4-P6 and pay the higher price. Quadrant 68 illustrates a recommendation from the objective function for more shelf space and higher price image for products P8, P9, and P10.

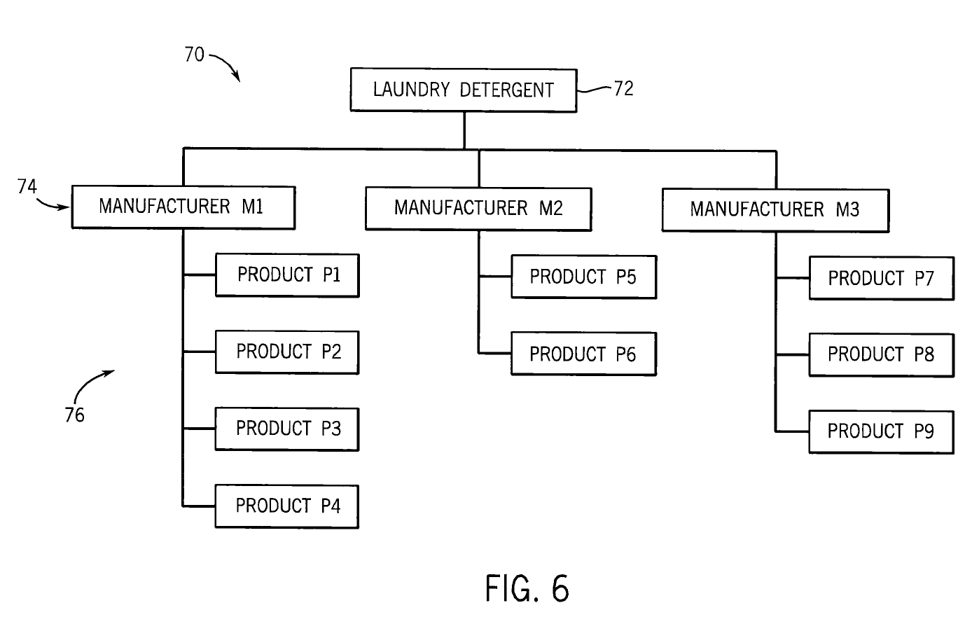

Another hierarchical structure 70 is shown in FIG. 6 as organizing products by brand hierarchy. Level 72 represents the top level of brands for a particular product, in this case laundry detergent. Level 74 shows individual manufacturers M1, M2, and M3, all providing their brand of laundry detergent. Level 76 represents specific branded products for each manufacturer M1-M3. Manufacturer M1 has branded products P1, P2, P3, and P4; manufacturer M2 has branded products P5 and P6; manufacturer M3 has branded products P7, P8, and P9.

As described above for structure 50, the hierarchical structure 70 of FIG. 6 allows retailer 12 to consider various groupings of its products organized by brand hierarchy. Through the hierarchical structure 70, retailer 12 can focus on a particular brand of a particular product for a given manufacturer. Alternatively, retailer 12 can focus on all brands of the same type of products for the same manufacturer, or retailer 12 can focus on all brands of a particular product for all manufacturers. In any case, the hierarchal structure 70 shown in FIG. 6 gives retailer 12 many different options in organizing the products to be optimized. The optimization can be performed at any node or group of nodes according to the hierarchical structure.

Again, each node of hierarchal structure 70, e.g. product P1 from manufacturer M1, can be represented as product function with a Lagrange multiplier similar to the functions shown in equation (9) of the simultaneous optimization process described above. The product function is based on the criteria that the product parameter represents. Each category of product for each department of each store has a unique set of historical data. For example, product P1 from manufacturer M1 represents one or more product(s) with historical data for sales, assortment, space, placement, promotion, inventory, price, etc. Other categories in hierarchical structure 70 will have different sets of historical data. The product function describes the behavior of the branded product. The Lagrange multiplier is a scalar multiplier uniquely assigned for each node of hierarchical structure 70 to control the effect of the product function on maximizing the objective function θ. That is, each Lagrange multiplier is a weighting factor with a numeric value used to control the effect of the branded product node(s) of FIG. 6 on the objective function θ. The Lagrange multiplier can be selected by retailer 12, e.g. as a normalized value between 0.0 to 1.0, to control the effect of the product function on the objective function. This control feature allows retailer 12 to evaluate different branded products from different manufacturers and allocate space for the individual brands according to the solution of the objective function. Thus, by viewing the structure 70 hierarchically, the branded product nodes(s) can be grouped and described as product functions with selectable and controllable scalar multipliers. The optimization for the objective function θ is then solved as described above for equations (9)-(24) to maximize its effect for the product decisions.

The product parameters and Lagrange multiplier(s) for the product nodes of FIG. 6 can be used in addition to product decision functions and control multipliers λ^{ds}, λ^{im}, and λ^{sa} of equation (9), or in lieu of one or more of these standard product decision control factors. The Lagrange multiplier(s) for the product nodes gives retailer 12 another means of controlling product decisions, e.g. to control brand and vendor strategies.

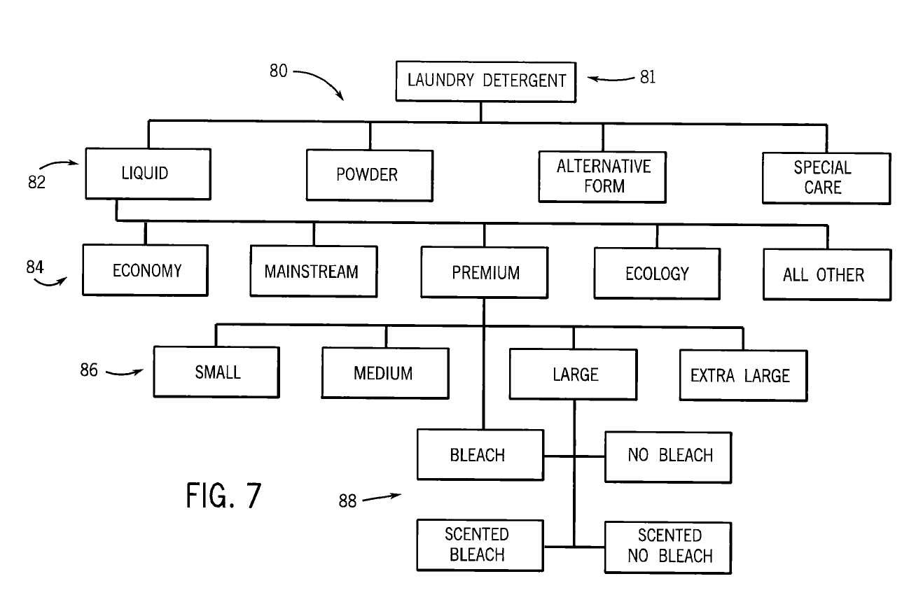

Another hierarchical structure 80 is shown in FIG. 7 as organizing products by customer decision tree. Level 81 represents the top level decision making for purchase of a particular product, in this case laundry detergent. Level 82 shows different physical forms of the product as liquid, powder, alternative form, and special care. In level 84, each physical form of the product will have different concentrations or features of the product. For example, the liquid form of the laundry detergent has economy, mainstream, premium, ecology, and all other concentrations. The other physical forms will also have their respective concentrations or features. In level 86, each concentration will have different sizes. For example, the premium concentration has small, medium, large, and extra large. The other concentrations will have their respective sizes available. In level 88, additional attributes for the products are provided, e.g. bleach, scented bleach, no bleach, and scented no bleach.

The hierarchical structure 80 of FIG. 7 allows retailer 12 to consider various groupings of its products organized by customer buying decision practices. Retailer 12 can focus the customer's buying habits in optimizing the product decisions.

Again, each node of hierarchal structure 80, e.g. bleach, large, premium, liquid laundry detergent, can be represented as product function with a Lagrange multiplier similar to the functions shown in equation (9) of the simultaneous optimization process described above. The product function describes the behavior of the particular product. The Lagrange multiplier is a scalar multiplier uniquely assigned for each node of hierarchical structure 80 to control the effect of the product function on maximizing the objective function θ. That is, each Lagrange multiplier is a weighting factor with a numeric value used to control the effect of the product node(s) of FIG. 7 on the objective function θ. The Lagrange multiplier can be selected by retailer 12, e.g. as a normalized value between 0.0 to 1.0, to control the effect of the product function on the objective function. This control feature allows retailer 12 to evaluate different products according to customer buying decisions and allocate space according to the solution of the objective function. Thus, by viewing the structure 80 hierarchically, the product nodes(s) can be grouped and described as product functions with selectable and controllable scalar multipliers. The optimization for the objective function θ is then solved as described above for equations (9)-(24) to maximize its effect for the product decisions.

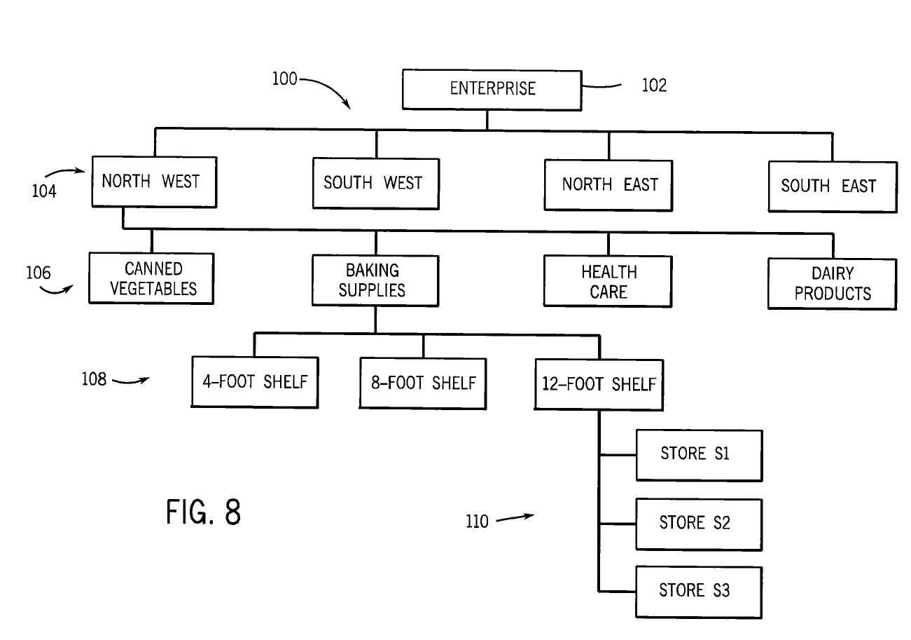

Another hierarchical structure 100 is shown in FIG. 8 as organizing products by assortment and price zones. Level 102 represents the enterprise level for the retail organization. Level 104 shows different geographical areas for the retail organization, such as northwest, southwest, northeast, and southeast. Level 104 is an example of pricing zones as different geographical areas may have different price images, i.e. northeast may be more expensive then southeast. The affluent part of town generally has higher prices than a low-income area. In level 106, different categories of products are considered. For example, northwest stores may carry canned vegetables, baking supplies, health care, and dairy products. Some product categories may be regional. Each region will have its respective product categories. In level 108, each product category has one of several assigned shelf areas. For example, baking supplies may be assigned to 4-foot shelf, 8-foot shelf, or 12-foot shelf. Other product categories will have their respective available shelving sizes. Level 108 is an example of an assortment zone as different shelf sizes can physically accommodate only a limited volume of product. In level 110, each shelf size is available in certain stores. For example, 12-foot shelves are available in store S1, S2, and S3. Other shelving sizes will be available in other stores.

The hierarchical structure 100 of FIG. 8 allows retailer 12 to consider various groupings of its products organized by assortment and price zones. Retailer 12 can focus relationships between price zones and assortment zones in optimizing the product decisions.

Again, each node of hierarchal structure 100, e.g. store S1, 12-foot shelf, baking supplies, northwest area of the retail enterprise, can be represented as node function with a Lagrange multiplier similar to the functions shown in equation (9) of the simultaneous optimization process described above. The node function describes the behavior of the particular node. The Lagrange multiplier is a scalar multiplier uniquely assigned for each node of hierarchical structure 100 to control the effect of the node function on maximizing the objective function θ. That is, each Lagrange multiplier is a weighting factor with a numeric value used to control the effect of the node(s) of FIG. 8 on the objective function θ. The Lagrange multiplier can be selected by retailer 12, e.g. as a normalized value between 0.0 to 1.0, to control the effect of the node function on the objective function. This control feature allows retailer 12 to evaluate different nodes according to pricing and assortment zones and allocate space according to the solution of the objective function. Thus, by viewing the structure 100 hierarchically, the nodes(s) can be grouped and described as functions with selectable and controllable scalar multipliers. The optimization for the objective function θ is then solved as described above for equations (9)-(24) to maximize its effect for the product decisions.

FIG. 9 illustrates a simplified computer system 120 for executing the software program used in the product decision modeling tool. Computer system 120 is a general-purpose computer including a central processing unit or microprocessor 122, mass storage device or hard disk 124, electronic memory 126, and communication port 128. Communication port 128 represents a modem, high-speed Ethernet link, or other electronic connection to transmit and receive input/output (I/O) data with respect to other computer systems.

Computer 120 is shown connected to communication network 130 by way of communication port 128. Communication network 130 can be a local and secure communication network such as an Ethernet network, global secure network, or open architecture such as the Internet. Computer systems 132 and 134 can be configured as shown for computer 120 or dedicated and secure data terminals. Computers 132 and 134 are also connected to communication network 130. Computers 120, 132, and 134 transmit and receive information and data over communication network 130.

When used as a standalone unit, computer 120 can be located in any convenient location. When used as part of a computer network, computers 120, 132, and 134 can be physically located in any location with access to a modem or communication link to network 130. For example, computer 120 can be located in the main office of retailer 12. Computer 132 can be located in one retail store. Computer 134 can be located in another retail store. Alternatively, the computers can be mobile and follow the users to any convenient location, e.g., remote offices, customer locations, hotel rooms, residences, vehicles, public places, or other locales with electronic access to communication network 130.

Each of the computers runs application software and computer programs which can be used to display user-interface screens, execute the functionality, and provide the features of the aforedescribed product decision modeling tool. In one embodiment, the screens and functionality come from the application software, i.e., the product decision modeling tool runs directly on one of the computer systems. Alternatively, the screens and functionality can be provided remotely from one or more websites on the Internet. The websites are generally restricted-access and require passwords or other authorization for accessibility. Communications through such websites may be encrypted using secure encryption algorithms. Alternatively, the screens and functionality are accessible only on the secure private network, such as Virtual Private Network (VPN), with proper authorization.

The software is originally provided on computer-readable media, such as compact disks (CDs), magnetic tape, or other mass storage medium. Alternatively, the software is downloaded from electronic links such as the host or vendor website. The software is installed onto the computer system hard drive 124 and/or electronic memory 126, and is accessed and controlled by the computer's operating system. Software updates are also electronically available on mass storage media or downloadable from the host or vendor website. The software, as provided on the computer-readable media or downloaded from electronic links, represents a computer program product usable with a programmable computer processor having a computer-readable program code embodied therein The software contains one or more programming modules, subroutines, computer links, and compilations of executable code, which perform the functions of the product decision modeling tool. The user interacts with the software via keyboard, mouse, voice recognition, and other user-interface devices connected to the computer system.

The software stores information and data related to the modeling tool in a database or file structure located on any one of, or combination of, hard drives 124 of the computers 120, 132, and/or 134. More generally, the information used in the modeling tool can be stored on any mass storage device accessible to computers 120, 132, and/or 134. The mass storage device for storing the modeling tool data may be part of a distributed computer system.

In the case of Internet-based websites, the interface screens are implemented as one or more webpages for receiving, viewing, and transmitting information related to the modeling tool. A host service provider may set up and administer the website from computer 120 located in the retailer's home office. The employee accesses the webpages from computers 132 and 134 via communication network 130.

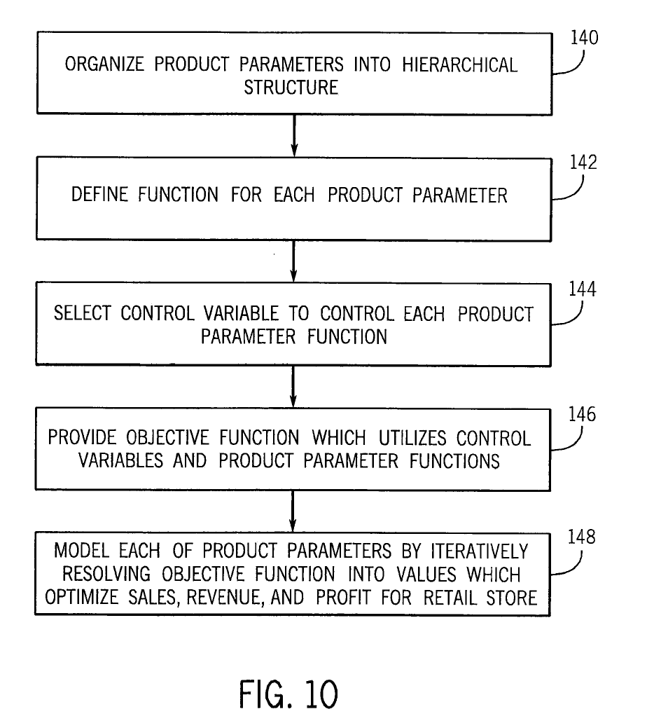

As further explanation, FIG. 10 illustrates a process flowchart of one embodiment of the product parameter modeling tool. In step 140, the product parameters are organized into a hierarchal structure, which may use a brand hierarchy, enterprise hierarchy, or customer buying decisions. In step 142, a function is defined for each product parameter. In steps 144, a control variable is selected to control each product parameter function. In step 146, an objective function utilizes the control variables and product parameter functions. In step 148, each of the product parameters are modeled by iteratively resolving the objective function into values which optimize sales, revenue, and profit for the retail store. The objective function model is resolved by using nested loops to solve for a first variable and then using the first variable to solve for a second variable. The modeling can be performed on all product parameter functions simultaneously.

While one or more embodiments of the present invention have been illustrated in detail, the skilled artisan will appreciate that modifications and adaptations to those embodiments may be made without departing from the scope of the present invention as set forth in the following claims.

What is claimed is:

1. A computer-implemented method of modeling product parameters in a retail store, comprising:
organizing product parameters into a hierarchal structure;
defining a function for each product parameter;
selecting a control variable to control each product parameter function;
providing an objective function that utilizes the control variables and product parameter functions; and
modeling each of the product parameters by iteratively resolving the objective function into values which optimize sales, revenue, and profit for the retail store.

2. The computer-implemented method of claim 1, wherein the modeling of each of the product parameters is performed simultaneously.

3. The computer-implemented method of claim 1, further including:
defining rules and constraints for a plurality of product decision variables;
providing the objective function in terms of the rules and constraints for the plurality of product decision variables; and
simultaneously modeling each of the plurality of product decision variables by resolving the objective function into values which optimize sales, revenue, and profit for the retail store.

4. The computer-implemented method of claim 1, wherein the hierarchical structure uses a brand hierarchy.

5. The computer-implemented method of claim 1, wherein the hierarchical structure uses an enterprise hierarchy.

6. The computer-implemented method of claim 1, wherein the hierarchical structure uses customer buying decisions.

7. The computer-implemented method of claim 1, wherein the model is output in graphic format.

8. The computer-implemented method of claim 1, wherein the objective function model is resolved by using nested loops to solve for a first variable and then using the first variable to solve for a second variable.

9. A computer program product usable with a programmable computer processor having a computer readable program code embodied therein, comprising:
computer readable program code which organizes product parameters into a hierarchal structure;
computer readable program code which defines a function for each product parameter;
computer readable program code which selects a control variable for each product parameter function;
computer readable program code which provides an objective function that utilizes the control variables and product parameter functions; and
computer readable program code which models each of the product parameters by iteratively resolving the objective function into values which optimize sales, revenue, and profit for the retail store.

10. The computer program product of claim 9, wherein the modeling each of the product parameters is performed simultaneously.

11. The computer program product of claim 9, wherein the hierarchical structure uses a brand hierarchy.

12. The computer program product of claim 9, wherein the hierarchical structure uses an enterprise hierarchy

13. The computer program product of claim 9, wherein the hierarchical structure uses customer buying decisions.

14. The computer program product of claim 9, wherein the model is output in graphic format.

15. The computer program product of claim 9, wherein the objective function model is resolved by using nested loops to solve for a first variable and then using the first variable to solve for a second variable.

16. A computer system for modeling product parameters in a retail environment, comprising:
means for organizing product parameters into a hierarchal structure;
means for defining a function for each product parameter;
means for selecting a control variable to control each product parameter function;
means for providing an objective function that utilizes the control variables and product parameter functions; and
means for modeling each of the product parameters by iteratively resolving the objective function into values which optimize sales, revenue, and profit for the retail store.

17. The computer system of claim 16, wherein the means for modeling of each of the product parameters is performed simultaneously.

18. The computer system of claim 16, further including:
means for defining rules and constraints for a plurality of product decision variables;
means for providing the objective function in terms of the rules and constraints for the plurality of product decision variables; and
means for simultaneously modeling each of the plurality of product decision variables by resolving the objective function into values which optimize sales, revenue, and profit for the retail store.

19. The computer system of claim 16, wherein the hierarchical structure uses a brand hierarchy.

20. The computer system of claim 16, wherein the hierarchical structure uses an enterprise hierarchy.

21. The computer system of claim 16, wherein the hierarchical structure uses customer buying decisions.

22. The computer system of claim 16, wherein the model is output in graphic format.

23. The computer system of claim 16, wherein the objective function model is resolved by using nested loops to solve for a first variable and then using the first variable to solve for a second variable.
